(19) United States
(12) Patent Application Publication
(10) Pub. No.: US 2020/0012335 A1
(43) Pub. Date: Jan. 9, 2020

(54) INDIVIDUAL VISUAL IMMERSION DEVICE FOR A MOVING PERSON WITH MANAGEMENT OF OBSTACLES

(71) Applicant: STEREOLABS, Montrouge (FR)

(72) Inventors: Cécile SCHMOLLGRUBER, Montrouge (FR); Edwin AZZAM, Montrouge (FR); Olivier BRAUN, Montrouge (FR); Aymeric DUJARDIN, Montrouge (FR); Abdelaziz BENSRHAIR, Montrouge (FR); Sébastien KRAMM, Montrouge (FR); Alexandrina ROGOZAN, Montrouge (FR)

(21) Appl. No.: 16/348,746

(22) PCT Filed: Nov. 6, 2017
(86) PCT No.: PCT/FR2017/053029

§ 371 Date: Sep. 18, 2019

(30) Foreign Application Priority Data
Nov. 9, 2016 (FR) 16 60833

(51) Int. Cl. G06F 3/01; G06T 19/00; G06F 3/0481; G06F 3/16; G02B 27/00

(52) U.S. Cl. CPC G06F 3/011; G06T 19/006; G06T 2207/20221; G06F 3/167; G02B 27/0093; G06F 3/04815

(57) ABSTRACT

An individual visual immersion device for a moving person including means for placing the device on the person and for displaying immersive images in front of the person's eyes, a stereoscopic camera, means for, during an initialization phase of the device in an operating zone including static obstacles, the device being moved in the operating zone, recording stereoscopic images of the operating zone from several points of view using the camera, then merging the images into a model of the operating zone, and interpreting the model to create a three-dimensional map of obstacles identified in the operating zone, and means for, during a usage phase of the device in the operating zone, the device being worn by a user, detecting whether the user is approaching one of the static obstacles identified in the map and then triggering an alert process.

### TECHNICAL FIELD

The disclosure relates to a virtual reality helmet intended to be worn by a user and comprising a system for broadcasting two synchronized streams of images and an optical system making it possible to view, correctly, with the left eye and the right eye, respectively, the images from the two streams, each eye having to see essentially or only the images from one of the two streams. It is possible to that end to use an essentially rectangular or oblong screen on which are broadcasted, on the left part and on the right part, the images from the two streams. It is also possible to use two synchronized screens positioned next to one another, which each display the corresponding left or right image, rather than a single screen.

The helmet incorporates a stereoscopic camera made up of two synchronized sensors, reproducing the field of view of the user's eyes. In particular, this camera is oriented toward the scene that the user could see if his eyes were not hidden by the helmet.

This camera is connected to a computing unit inside or outside the helmet allowing the processing of images coming from the two sensors.

One possible image processing is a series of algorithms making it possible to extract the depth map of the scene, then to use this result with the associated left and right images to deduce the change of position and orientation of the camera therefrom between two consecutive view acquisition moments (typically separated by a sixtieth of a second).

These different results can be used to display a virtual reality model (typically a game or a professional simulation) on the screen and to modify the virtual point of view by adapting it to the current position and orientation of the camera in space. It is also possible to coherently mix a stream of virtual images or objects in the real scene filmed by the camera. This is then called augmented reality.

### BACKGROUND

The system described in patent application FR 1,655,388 dated Jun. 10, 2016 comprises a stereoscopic camera in a mixed reality helmet. For augmented reality applications, the integrated screen coupled with the acquisition system allows the user to see the real world facing him, to which virtual images are added. The user is then capable of detecting many real objects (obstacles) around him. However, in the case of a virtual reality application, the immersion in the real world is complete, and no visual feedback then makes it possible to anticipate collisions. The immersion in the system can cause a loss of reference of the user, and negligence of the objects present around him.

The system described in document US20160027212A1 proposes to use the depth information to identify the elements closest to the user and thus detect the obstacles. The depth sensor is positioned on the helmet, when an object is at a defined threshold distance, the obstacle is displayed overlaid on the content on the screen of the device, warning the user of the danger facing him. This system is only capable of detecting the objects in front of the user and in the zone covered by the depth sensor. Any object on the ground, behind the user or on the sides is not visible: movement toward these obstacles is therefore not taken into account by this system.

One is thus faced with the absence of a comprehensive solution for managing collision problems between a virtual reality helmet user and the objects in his environment. In general, it is desirable to improve the experience of the user and his safety.

### BRIEF SUMMARY

The disclosure relates to a system for detecting moving or static obstacles for a virtual reality helmet with a stereoscopic camera capable of mapping the environment a priori, then identifying the location of the helmet in order to warn the user in case of collision risk with an object. The system offers handling of certain obstacles, namely static obstacles, even if they are outside the field of vision of the camera of the helmet.

The disclosure therefore proposes to manage the dynamic and static objects, even outside the field of view, by a priori mapping of the zone.

The disclosure is an extension of the system of patent application FR 1,655,388, but its application is not limited to this system. It meets the user's need for not walking blindly while wearing the helmet. It makes it possible to move in a defined space in complete safety, independently of the movements and orientation of the device.

The system uses a stereoscopic camera, the depth map computed from two images, and the position of the camera in space.

More specifically, proposed is an individual visual immersion device for a moving person comprising means for placing the device on the person and for displaying immersive images in front of the person's eyes, and also comprising a stereoscopic camera, characterized in that it comprises
means for, during an initialization phase of the device in an operating zone comprising static obstacles, the device being or not being moved in the operating zone, recording stereoscopic images of the operating zone from several points of view using the camera, then merging said images into a model of the operating zone, and interpreting said model to create a three-dimensional map of obstacles identified in the operating zone,
and means for, during a usage phase of the device in the operating zone, the device being worn by a user, detecting whether the user is approaching one of the static obstacles identified in said map and then triggering an alert process.

According to advantageous and optional features, it is also observed that
said images are merged into a model of the operating zone by looking, in said different images, for pixels corresponding to a same point of the operating zone, and merging said pixels so as not to introduce redundant information, or at least to limit the redundant information, in the model;
the pixels corresponding to a same point of the operating zone identified using a distance or using a truncated signed distance function volume;
a safety perimeter defined around the user or an extrapolation of a future position of the user based on a history of the positions of the user is used to detect whether the user is approaching one of the static obstacles identified in said map;
the initialization phase comprises the storage of points of interest associated with their respective points of the operating zone, and the usage phase comprises a localization of the user with respect to the map using at least one of said points;
the points of interest are chosen as a function of an overlap criterion to cover the operating zone while limiting redundancies, chosen on instruction from the user or chosen regularly over time during a movement of the device during the initialization phase;
the stereoscopic camera comprises two image sensors and a means for computing disparity information between images captured by the two sensors in a synchronized manner;
the device comprises means for, during the usage phase of the device in the operating zone, the device being worn by a user, capturing stereoscopic images corresponding to a potential field of view of the user, analyzing said images corresponding to the potential field of view to detect a potential additional obstacle therein and, if the user approaches said potential additional obstacle, then triggering an alert process;
the means for analyzing the images to detect a potential additional obstacle are implemented simultaneously with the means for detecting whether the user is approaching one of the static obstacles identified on the map;
the alert process comprises emitting a sound, displaying an obstacle image overlaid on immersive images if such an overlay is spatially founded, displaying an indication symbolic of an obstacle with an indication of the relevant direction, or displaying an imaged depiction if the user and the obstacle are close to one another.

### BRIEF DESCRIPTION OF THE DRAWINGS

The disclosure will now be described in reference to the figures, among which:

FIG. 1 is a flowchart showing the initialization function of the system in one embodiment of the disclosure;

FIG. 2 is an illustration of one aspect of the processes according to the disclosure;

FIG. 3 is a flowchart showing the operation during use of the embodiment of the system initialized according to FIG. 1;

FIG. 4 is an illustration of one aspect of the processes according to the disclosure;

FIG. 5 is an illustration of the movement of a user of the system and the implementation of its obstacle detection functions.

### DETAILED DESCRIPTION

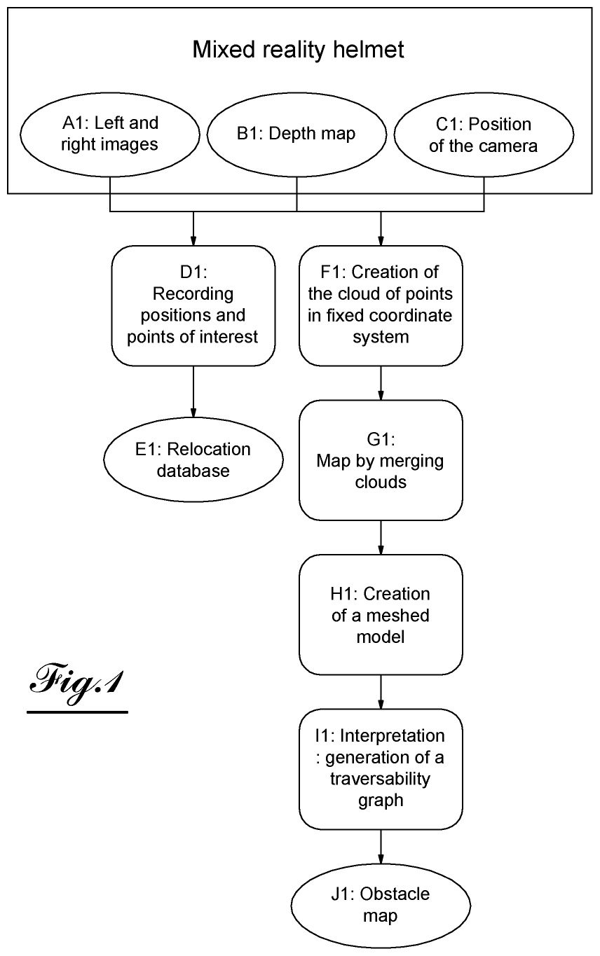

FIG. 1 shows the initialization mode of the system. The system is made up of a virtual reality helmet. The helmet is called mixed reality helmet because information from the real world is introduced into the virtual reality presented to the user, but the virtual reality constitutes the main part of the latter's experience.

The helmet has a module A1 for acquiring left and right images coming from two sensors pointed toward a same half-space, and positioned next to one another so as to provide a binocular view on part of this half-space. These two sensors are synchronized.

The helmet also comprises a module B1 for generating a disparity map, in the case at hand a dense depth map that is computed using synchronized pairs of images obtained from the two sensors. Thus, these two sensors constitute a depth sensor.

The helmet also comprises an odometry module C1 making it possible to estimate the position of the moving device. This may be a visual odometry system or visual odometry completed by the information supplied by an inertial unit.

The initialization of the system can only be done once per use. Typically, it is only done if the operating zone has changed, in general by moving objects.

The aim sought during the initialization phase is to create a map of the static obstacles in the zone. To that end, the user must travel the zone with the device comprising the stereo camera. The environment is then mapped, then processed.

The user wears the device on his head or carries it in his hand and moves over the entire operating zone, with the instruction of exploring all of the real obstacles in the operating zone with the stereoscopic capture system. Upon each image (and therefore typically 60 times per second), a dense depth map is computed using two obtained images coming from two depth sensors, using modules A1 and B1. In the case of a simple operating zone, the user can not move, and simply turn the helmet to sweep the environment. To that end, he can place the helmet on his head and turn it without moving. In the case of a complex zone, it is desirable to move therein in order to map it, and to prevent the user from colliding with the obstacles, it is simpler for him to hold the helmet in his hand.

The position in space of the camera is also determined, using the module C1, for each image capture moment.

Two processes next occur.

First, the module C1 commands the recording of images or visible characteristics making up points of interest, and the recording in memory of the position of the helmet at the observation moment of these points. This process is shown D1 in FIG. 1. This process seeks to cover the zone traveled by the user, while making up a database of points of interest. The triggering of a recording of a new entry in the database thus formed preferably takes place as a function of an overlap criterion that determines the quantity of redundant information with the other entries in the database. Other criteria can be used such as the manual triggering of a recording by the user, computing a physical distance between each position of the points of interest or a length of time elapsed between two recordings.

A database E1 is thus built. It contains a set of reference positions associated with characteristics or images at the time of initialization. It is called relocation base, since it is next used, during the use of the device, to relocate the latter.

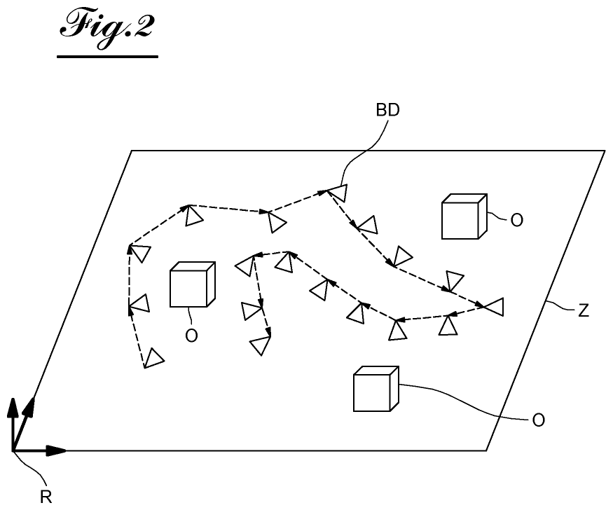

The process that has just been described is illustrated in FIG. 2. This FIG. shows spatial coordinate R with reference set as a function of the first acquisition, various obstacles O in the operating zone Z. The database BD is built by recording images or points of interest, the spatial positions of which are kept. The database BD will next be called relocation database, and used to allow the device to locate itself in space for a usage phase.

In parallel, the depth map B1 and the parameters of the stereoscopic system are used to generate a cloud of points, projecting each pixel of the image in order to obtain coordinates of points in the space.

The points in the space next undergo a change of coordinate system by using the information relative to the position of the helmet in the space derived from the odometry module C1 in order to place all of the points captured during the initialization phase in a fixed shared coordinate system. This is done by the module F1.

These sets of points are merged during operation G1 in order to create a dense model (map) of the operating zone while reducing the quality of redundant information. This process can be done for example by traveling the sets of points and merging the points identified as being close to one another as a function of a distance or using a truncated signed distance function (TSDF) volume.

A subsequent step H1 comprises of generating a mesh in the set of points in three dimensions. This mesh is made up of connected triangles, modeling the surfaces of the operating zone.

When the user has traveled the entire operating zone, the model is interpreted during a step I1 in order to extract the free zones and the obstacles. The ground is identified by the system, for example by approximating a plane on the mesh by an iterative method or by computing the vectors of the normal directions on a subset of the mesh to determine the main orientation thereof.

The visible elements are considered to be obstacles as a function of their sizes. The size threshold used is automatically refined or adjusted by the user.

One thus generates a traversability graph.

This results in an obstacle map J1. The latter can next be used during uses of the system in the operating phase.

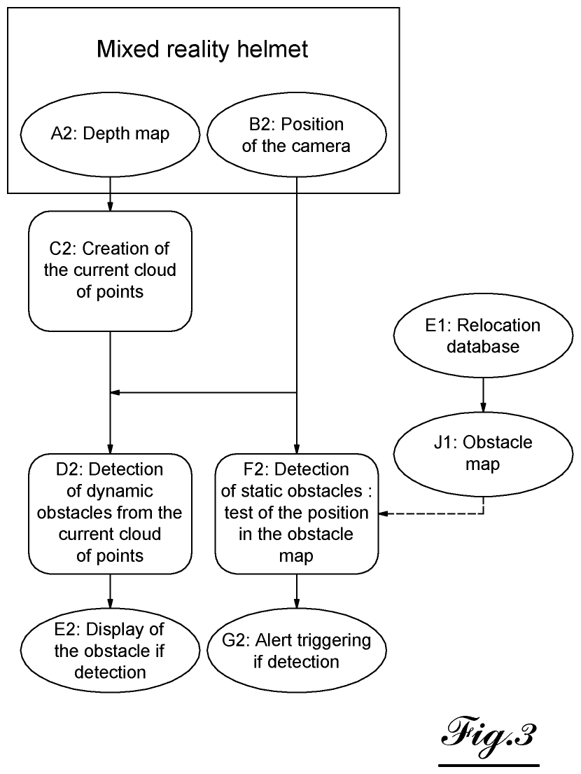

FIG. 3 shows the device in the operating and usage phase of the helmet. The system first reloads the map.

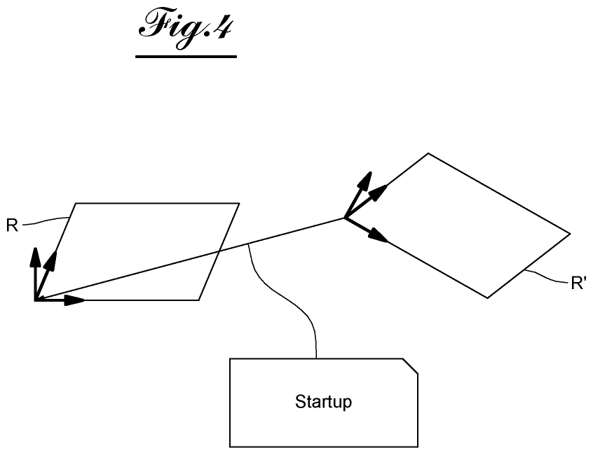

Upon starting up, the system loads the map of static obstacles in the operating zone. It then determines its position. This is shown in FIG. 4.

To that end, it matches the spatial positions between the instantaneous real world and the world previously recorded during the initialization phase.

To that end, the user makes it possible, without having to move in the operating zone, for his helmet to observe the environment, and to determine the depth map A2.

A match is sought for the current images, limited in number (for example a single image) coming from the camera and the elements of the database BD called relocation base E1. When a visual match is found between a current observation and an entry in the database, the associated position in the database is extracted and used, to make the coordinate R that had been used during the initialization phase, and the current coordinate R′, match. This is a startup phase of the system. This involves making the connection between the coordinate of the obstacle map J1, computed in the initialization phase, and the coordinate of the helmet in the current material environment. If needed, for greater precision, the distance is used between the locations identified in the database E1. It is also possible to use the depth information present in the current image viewed by the helmet. A correction is applied by computing the difference between the current position of the helmet and the recorded position, to thus relocate the helmet.

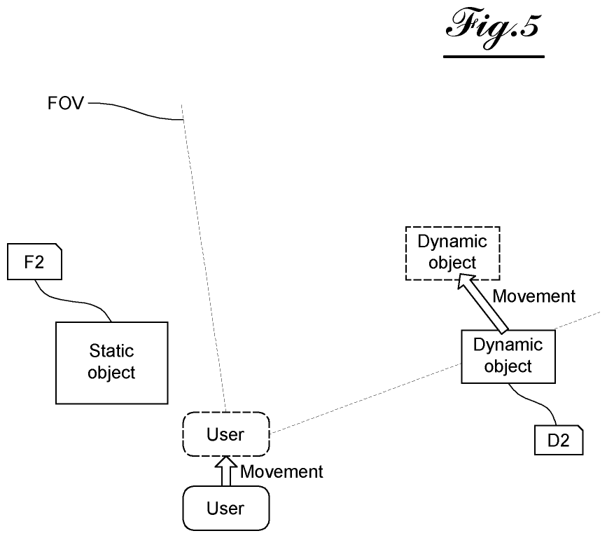

After having initialized this position, the system launches the detections, which are shown in FIG. 5. Two functions are launched: a static function F2 that uses the obstacle map from the initialization phase, to indicate to the user all of the objects toward which he is moving that are too close, independently of the location where the user is looking; and in parallel, a detection of dynamic obstacles D2, capable of detecting all of the obstacles in the field of view of the system FOV, even if they were not present during the initialization phase, typically such as a person or an animal passing through the operating zone.

From this moment, the user can move.

The system uses an odometry function B2 to track the position of the user on the obstacle map J1 so as to be able to trigger an alert if he risks encountering an obstacle.

Two obstacle detection systems in the usage phase are next used simultaneously, while the user is involved in a virtual reality experience.

The first obstacle detection system D2 detects the obstacles visible by the camera, which can therefore be dynamic. It bases itself, to determine the presence of obstacles, only or first on a current cloud of dots in three dimensions C2, and optionally on the odometry information B2.

The current cloud C2 is generated from the current depth map A2. For obstacle proximity detection, a threshold is set that can be a distance from the obstacles. The system then looks, via the module D2, for elements of the cloud of dots in a sphere with a radius of this threshold around the player. The threshold can also be a time taking into account the direction and speed of the current movement, given by the odometry module B2, extrapolated to evaluate the presence of obstacles in the trajectory on the basis of the cloud C2.

When a likely collision is detected, an alert E2 is triggered and a warning is launched for the user, for example by displaying the obstacle overlaid on the virtual content.

This handling of dynamic obstacles entering the field of view FOV of the helmet is shown in FIG. 5 by reference D2.

A second obstacle detection system F2 uses the static obstacle map J1, and the spatial position obtained by the odometer B2. At each moment, a new position obtained by the odometer B2 is given and the system tests the position in the obstacle map J1.

Two operating modes are possible.

A first mode determines whether objects are found in a safety perimeter of defined size around the user. If at least one object is found, the system determines that there is a danger and alerts the user through an alert process G2.

A second mode uses the position history to deduce a movement vector therefrom, and to extrapolate the future position by hypothesizing that the movement will be locally constant. The system is then capable of determining whether an obstacle is on the path. In case of detection of an object, an alert process G2 is triggered to warn the user.

This handling of pre-identified static obstacles entering or not entering the field of view FOV of the helmet is shown in FIG. 5 by reference F2.

The alerts can be of several intensities and different natures: spatialized sound, overlaid display of obstacles, display of an indication of obstacles in the relevant direction (colored arrows or border, for example). It is also possible to display a so-called “third-person” view of the user with the modeled environment and the closest obstacles.

1. An individual visual immersion device for a moving person comprising:
means for placing the device on the person and for displaying immersive images in front of the person's eyes;
a stereoscopic camera;
means for, during an initialization phase of the device in an operating zone comprising static obstacles, recording stereoscopic images of the operating zone from several points of view using the camera, then merging said images into a model of the operating zone, and interpreting said model to create a three-dimensional map of obstacles identified in the operating zone; and
means for, during a usage phase of the device in the operating zone, the device being worn by a user, detecting whether the user is approaching one of the static obstacles identified in said map and then triggering an alert process.

2. The visual immersion device according to claim 1, wherein said images are merged into a model of the operating zone by looking, in said different images, for pixels corresponding to a same point of the operating zone, and merging said pixels so as not to introduce redundant information, or at least to limit the redundant information, in the model.

3. The visual immersion device according to claim 2, wherein the pixels corresponding to a same point of the operating zone identified using a distance or using a truncated signed distance function volume.

4. The visual immersion device according to claim 1, wherein a safety perimeter defined around the user or an extrapolation of a future position of the user based on a history of the positions of the user is used to detect whether the user is approaching one of the static obstacles identified in said map.

5. The visual immersion device according to claim 1, wherein the initialization phase comprises the storage of points of interest associated with their respective points of the operating zone, and the usage phase comprises a localization of the user with respect to the map using at least one of said points.

6. The visual immersion device according to claim 5, wherein the points of interest are chosen as a function of an overlap criterion to cover the operating zone while limiting redundancies, chosen on instruction from the user or chosen regularly over time during a movement of the device during the initialization phase.

7. The visual immersion device according to claim 1, wherein the stereoscopic camera comprises two image sensors and a means for computing disparity information between images captured by the two sensors in a synchronized manner.

8. The visual immersion device according to claim 1, wherein it further comprises means for, during the usage phase of the device in the operating zone, the device being worn by a user, capturing stereoscopic images corresponding to a potential field of view of the user, analyzing said images corresponding to the potential field of view to detect a potential additional obstacle therein and, if the user approaches said potential additional obstacle, then triggering an alert process.

9. The visual immersion device according to claim 8, wherein the means for analyzing the images to detect a potential additional obstacle are implemented simultaneously with the means for detecting whether the user is approaching one of the static obstacles identified on the map.

10. The visual immersion device according to claim 1, wherein the alert process comprises emitting a sound, displaying an obstacle image overlaid on immersive images if such an overlay is spatially founded, displaying an indication symbolic of an obstacle with an indication of the relevant direction, or displaying an imaged depiction if the user and the obstacle are close to one another.
